(19) United States
(12) Patent Application Publication
(10) Pub. No.: US 2006/0071124 A1
(43) Pub. Date: Apr. 6, 2006

(54) Reinforced structural assembly having a lap joint and method for forming the same

(75) Inventors: Keith A. Young, St. Peters, MO (US); Kevin G. Waymack, Hazelwood, MO (US); Ryan L. Hanks, Bunkerhill, IL (US)

Correspondence Address: BLACK LOWE & GRAHAM PLLC, 701 FIFTH AVENUE, SUITE 4800, SEATTLE, WA, 98104, US

(73) Assignee: The Boeing Company

(21) Appl. No.: 10/955,501

(22) Filed: Sep. 30, 2004

(51) Int. Cl. B64C 30/00

(52) U.S. Cl. 244/117 R; 244/133

(57) ABSTRACT

Reinforced structural assemblies and methods for forming such assemblies are disclosed. In one embodiment, a reinforced structural assembly includes an engagement portion having at least one projecting structure extending outwardly from the engaging structure, and a receiving portion having at least one recessed structure that slidably receives and fixably retains the projecting structure. In another embodiment, a method for constructing a reinforced structural assembly includes positioning at least one projecting structure on a first substrate, positioning at least one recessed structure on a second substrate. The at least one projecting structure and the at least one recessed structure are slidably coupled and fixably secured.

### FIELD OF THE INVENTION

This invention relates generally to materials construction, and more particularly to reinforced structural assemblies and methods for forming such assemblies.

### BACKGROUND OF THE INVENTION

Reinforced structures are widely used in many industries and in many diverse applications. For example, aircraft, spacecraft, terrestrial and marine vehicles often employ a variety of planar, curved and multiple-contoured reinforced structures. The foregoing reinforced structures generally include a lightweight core material that is positioned between a pair of spaced apart and generally parallel face sheets. Since the bending stiffness of the reinforced structure substantially increases as the core thickness is increased, such structures advantageously provide a lightweight and effective means for resisting bending loads.

One commonly used reinforced structure includes an interconnected honeycomb core structure having a selected thickness that is positioned between the face sheets. Although the foregoing reinforced structure is effective in resisting high bending loads, some disadvantages nevertheless exist. For example, since the core material must be bonded to the face sheets by adhesives, brazing or other similar processes at many discrete locations, portions of the core material may be insufficiently bonded to the face sheets during fabrication of the structure that result in localized weaknesses within the structure. Moreover, if the structure sustains physical damage while in service, the structure is typically repaired by cutting the face sheets and the core material to remove the damaged portion. Repair procedures of this type may cause further debonding of the core material from the face sheets, which is not readily detectable by commonly used inspection procedures.

Another commonly used reinforced structure employs a closed network of discrete ribs that extend between opposed and spaced apart face sheets. The ribs are generally coupled to the face sheets by fixedly positioning edges of the ribs into receiving grooves that are machined or otherwise formed in the face sheets. One example of the foregoing reinforced structure is the GRID-LOCK structural system available from Rohr, Inc. of Chula Vista Calif. Although the foregoing system addresses some of the shortcomings present in structures having a honeycomb core material, still other shortcomings are present. For example, the machined receiving grooves require a small diameter tool to form the elongated grooves, which is time consuming and generally increases the production costs associated with the fabrication of the reinforced structure. Moreover, the relatively thin ribs are typically positioned in relatively shallow receiving grooves that provide a limited bond contact area. Accordingly, such structures must include a relatively large number of ribs and/or thicker face sheets in order to provide the desired flexural strength.

Accordingly, what is needed in the art is a lightweight reinforced structure that is conveniently and inexpensively fabricated, while providing high flexural rigidity.

### SUMMARY OF THE INVENTION

The present invention is directed to reinforced structural assemblies and methods for forming such assemblies. In one aspect, a reinforced structural assembly includes an engagement portion having at least one circumferential projecting structure extending outwardly from the engaging structure, and a receiving portion having at least one circumferential recessed structure that slidably receives and fixably retains the projecting structure.

In another aspect, a method for constructing a reinforced structural assembly includes positioning at least one projecting structure on a first substrate, and positioning at least one circumferential recessed structure on a second substrate. The at least one circumferential projecting structure and the at least one circumferential recessed structure are slidably coupled and fixably secured.

### BRIEF DESCRIPTION OF THE DRAWINGS

Preferred and alternate embodiments of the present invention are described in detail below with reference to the following drawings.

FIG. 1 is a partial plan view of the reinforced structural assembly according to an embodiment of the invention;

FIG. 2 is an exploded, partial isometric view of the embodiment of FIG. 1;

FIGS. 3a and 3b are respective cross sectional views of portions of the embodiment of FIG. 1;

FIG. 4 is a partial cross sectional view of the embodiment of FIG. 1;

FIG. 5 is a partial isometric view of a reinforced structural assembly according to another embodiment of the invention;

FIG. 6 is a partial cross sectional view of the embodiment of FIG. 5; and

FIG. 7 is a side elevation view of an aircraft having one or more of the disclosed embodiments of the present invention.

### DETAILED DESCRIPTION

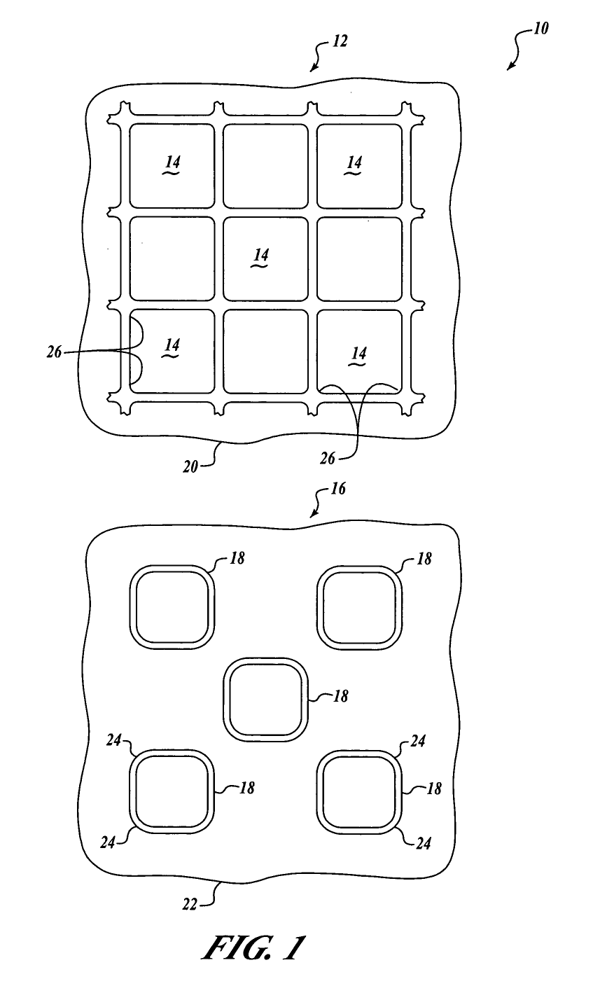

The present invention relates to reinforced structural assemblies and methods for forming such assemblies. Many specific details of certain embodiments of the invention are set forth in the following description and in FIGS. 1 through 7 to provide a thorough understanding of such embodiments. One skilled in the art, however, will understand that the present invention may have additional embodiments, or that the present invention may be practiced without several of the details described in the following description.

FIG. 1 is a partial plan view of the reinforced structural assembly 10 according to an embodiment of the invention, which shows respective disengaged portions of the assembly 10. The assembly 10 includes a receiving portion 12 having at least one recessed structure 14, and an engagement portion 16 having at least one projecting structure 18 configured to engage the recessed structure 14 of the receiving portion 12. The receiving portion 12 includes a supporting substrate 20 that is fixedly coupled to the recessed structures 14. Similarly, the engagement portion 16 also includes a supporting substrate 22 that is fixedly coupled to the projecting structures 18. Accordingly, when the projecting structure 18 is received into the recessed structure 14, the respective supporting substrates 20 and 22 form opposing external sides of the reinforced structural assembly 10, which may form a portion of a structural panel, such as a floor panel or a wing panel for an aircraft, or other similar structures.

In some embodiments, the receiving portion 12 and the engagement portion 16 may be formed from any suitable, substantially rigid material, which may include any ferrous material, or alternately any non-ferrous material, such as aluminum, a stainless alloy or titanium. The receiving portion 12 and the engagement portion 16 may also be formed from selected polymeric materials, which may also include polymeric materials that are reinforced by fiber elements embedded in the polymeric material, such as carbon fibers, or other like materials. The receiving portion 12 and the engagement portion 16 may also be formed as composite structures, wherein the recessed structure 14 and the projecting structure 18 are formed as separate elements and then fixedly positioned onto respective supporting substrates 20 and 22 by a variety well-known material joining methods. For example, when the recessed structure 14 and the supporting substrate 20 are comprised of a metal, the structure 14 and the substrate 20 may be joined by various fusion processes, such as welding or brazing. Similarly, the projecting structure 18 and the supporting structure 22 may also be joined by a fusion process when the projecting structure 18 and the supporting substrate 22 are formed from a metal. Alternately, when the recessed structure 14, the projecting structure 18 and the respective supporting substrates 20 and 22 are formed from a polymeric material, a suitable adhesive material may be employed to bond the recessed structure 14 to the substrate 20 and the projecting structure 18 to the substrate 22.

Still referring to FIG. 1, the recessed structure 14 and the projecting structure 18 are depicted as having a rectangular and closed planform shape, so that the projecting structure “telescopes” (or is slidably received) into the recessed structure 14 during fabrication of the assembly 10. It is understood, however, that the recessed structure 14 and the projecting structure 18 may have any regular polygonal shape in planform, and may further also be circular. In the embodiment shown in FIG. 1, the projecting structure 18 includes corners 24 having a radius that is greater than the corners 26 in the recessed structure 14. This feature permits the recessed portion 14 to receive the projecting structure 18 without experiencing excessive binding or interference, which advantageously assists in fabricating the assembly 10.

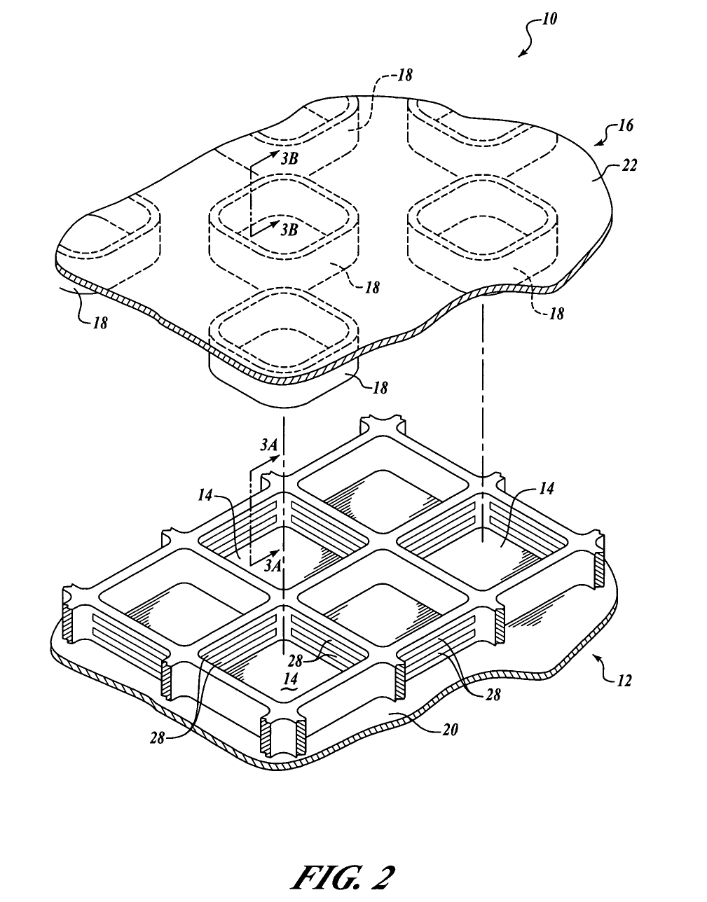

FIG. 2 is an exploded, partial isometric view of the assembly 10 of FIG. 1, which will be used to describe the assembly 10 in greater detail. The recessed structure 14 further includes at least one recess 28 formed in an interior portion of the recessed structure 14 that assists the recessed structure 14 to retain the projecting structure 18 when the structure 18 is positioned within the recessed structure 14. Accordingly, the recess 28 may be used to retain a volume of an adhesive material, such as an epoxy resin, that is applied to the interior portion of the recessed structure 14. Alternately, the recess 28 may also be used to retain a portion of a brazing alloy that may be used to fixably join the projecting structure 18 to the recessed portion 14. Although the recess 28 is shown as a longitudinal groove that extends partially along the interior portion of the recessed structure 14, it is understood that the recess 28 may have a variety of other shapes and orientations. For example, the recess 28 may have a serpentine or saw tooth shape. Moreover, the recess 28 may extend around substantially the entire interior portion of the recessed structure 14. Alternately, the recess 28 may extend about only a portion of the interior portion of the recessed structure 14. The projecting structure 18 includes a relatively smooth outer portion that abuts the recess 28 in the interior portion of the recessed structure 14 when the receiving portion 12 is joined to the engagement portion 16. The recessed portion 14 and the projecting structure 18 are generally configured to minimize the amount of the adhesive material between the recessed portion 14 and the projecting structure 18, so that the adhesive material is substantially retained within the recess 28.

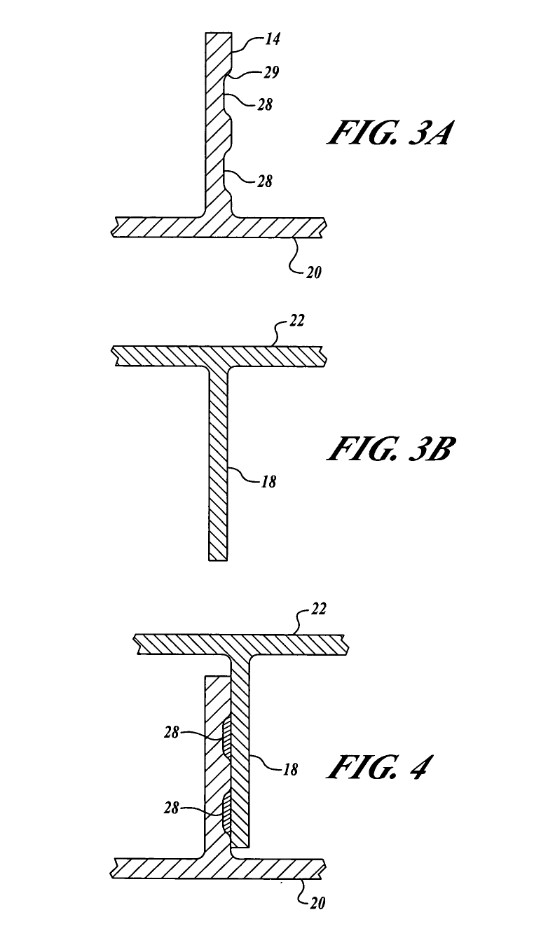

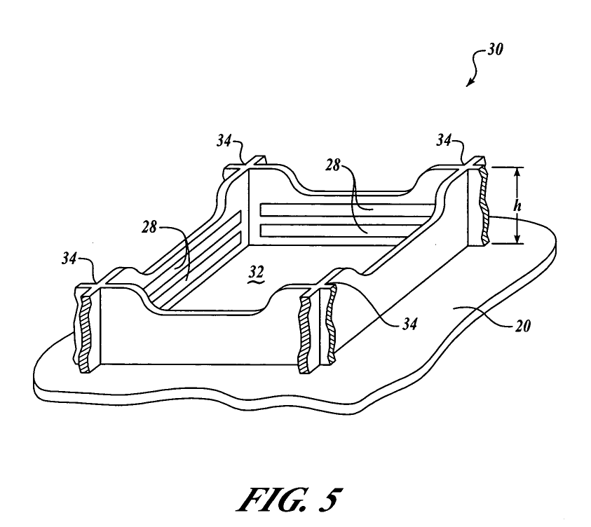

With reference briefly to FIG. 3a and FIG. 3b, cross sections of the recessed structure 14 and the projecting structure 18 are shown, respectively. With reference first to FIG. 3a, the recess 28 may extend into the interior portion of the recessed portion 14 to a relatively shallow depth, which advantageously limits the amount of machining required within the recessed portion 14. Further, the recess 28 may be formed so that the recess 28 includes a relatively large radius 29 on opposing sides of the recess 28. Consequently, regions of elevated stress concentration are minimized. Although two recesses 28 are shown in FIG. 3b, it is understood that one, or more than two recesses 28 may be present. Turning now to FIG. 3b, the projecting structure 18 is relatively uniform in cross section so that the adhesive material is retained within the recess 28 of FIG. 3a when the recessed structure 14 and the projecting structure 18 are substantially abutting, as shown in detail in FIG. 4. Although the projecting structure 18 is shown having a relatively uniform cross section, it is understood that the projecting structure 18 may include one or more recesses of the type shown in FIG. 3a. Alternately, and in other particular embodiments of the invention, the recess 28 may not be present in either the projecting structure 18 or the recessed structure 14, so that the projecting structure 18 and the recessed structure 14 are fixably coupled by mechanical interference.

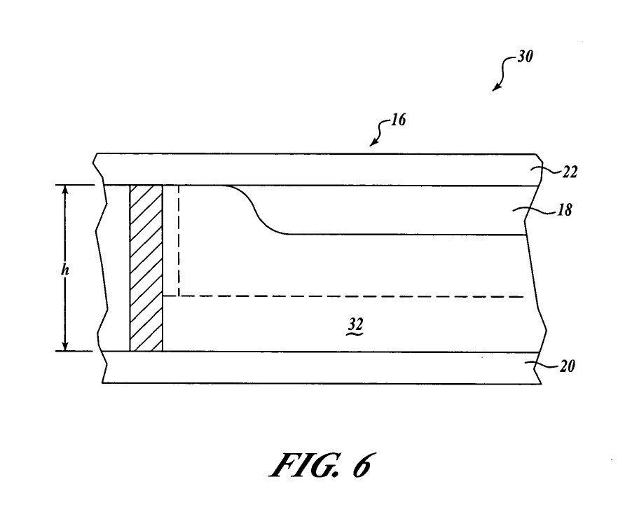

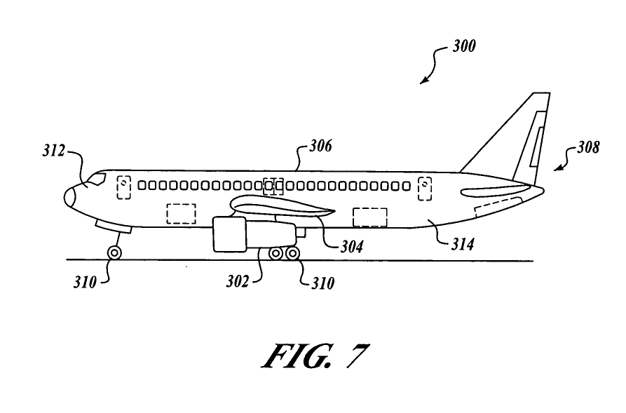

FIG. 5 is a partial isometric view of a reinforced structural assembly 30 according to another embodiment of the invention. The assembly 30 includes a recessed structure 32 that is fixedly positioned on a supporting substrate 20. The recessed structure 32 is configured to receive the projecting structure 18 of the engagement portion 16 of FIG. 1 to form the assembly 30. For clarity of illustration, the engagement portion 16 is not shown in FIG. 5. The recessed structure 32 includes at least one recess 28 that is formed in the interior of the recessed structure 32. The recessed structure 32 further includes raised corner regions 34 that advantageously permit a thickness h of the recessed structure 32 to be increased so that the flexural stiffness of the assembly 30 may be increased while avoiding a significant increase in weight for the assembly 30. FIG. 6 is a partial side view of the assembly 30 that shows the projecting structure 18 of the engagement portion 16 of FIG. 1 positioned in the recessed structure 32 of the assembly 30. As shown therein, the thickness h may be altered for the recessed structure 32 without alteration of the engagement portion 16. Accordingly, the flexural stiffness of the assembly 30 may be tailored to accommodate a selected application by alteration of only the recessed structure 32. This feature advantageously permits a component inventory to be minimized since the recessed structure 32 may be easily reconfigured to provide various thicknesses h.

Those skilled in the art will also readily recognize that the foregoing embodiments may be incorporated into a wide variety of different systems. Referring now in particular to FIG. 7, a side elevation view of an aircraft 300 having one or more of the disclosed embodiments of the present invention is shown. With the exception of the embodiments according to the present invention, the aircraft 300 includes components and subsystems generally known in the pertinent art, and in the interest of brevity, will not be described further. The aircraft 300 generally includes one or more propulsion units 302 that are coupled to wing assemblies 304, or alternately, to a fuselage 306 or even other portions of the aircraft 300. Additionally, the aircraft 300 also includes a tail assembly 308 and a landing assembly 310 coupled to the fuselage 306. The aircraft 300 further includes other systems and subsystems generally required for the proper operation of the aircraft 300. For example, the aircraft 300 includes a flight control system 312 (not shown in FIG. 7), as well as a plurality of other electrical, mechanical and electromechanical systems that cooperatively perform a variety of tasks necessary for the operation of the aircraft 300. Accordingly, the aircraft 300 is generally representative of a commercial passenger aircraft, which may include, for example, the 737, 747, 757, 767 and 777 commercial passenger aircraft available from The Boeing Company of Chicago, Ill. Although the aircraft 300 shown in FIG. 7 generally shows a commercial passenger aircraft, it is understood that the various embodiments of the present invention may also be incorporated into flight vehicles of other types. Examples of such flight vehicles may include manned or even unmanned military aircraft, rotary wing aircraft, ballistic flight vehicles or orbital vehicle, as illustrated more fully in various descriptive volumes, such as Jane's All The World's Aircraft, available from Jane's Information Group, Ltd. of Coulsdon, Surrey, UK. Additionally, those skilled in the art will readily recognize that the various embodiments of the present invention may also be incorporated into terrestrial or even marine vehicles.

With reference still to FIG. 7, the aircraft 300 may include one or more of the embodiments of the reinforced structural assembly 314 according to the present invention, which may be incorporated into various structural portions of the aircraft 300. In addition, the various embodiments of the present invention may also be incorporated into the various systems and sub-systems of the aircraft 300.

While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

What is claimed is:

1. A reinforced structural assembly, comprising:
an engagement portion having at least one projecting structure extending outwardly therefrom; and
a receiving portion having at least one recessed structure and having an interior region configured to slidably receive and fixably retain the at least one projecting structure.

2. The reinforced structural assembly of claim 1, wherein the engagement portion further includes a supporting substrate coupled to the projecting structure.

3. The reinforced structural assembly of claim 1, wherein the receiving portion further includes a supporting substrate coupled to the recessed structure.

4. The reinforced structural assembly of claim 1, wherein the engagement portion includes a projecting structure having a regular polygonal shape.

5. The reinforced structural assembly of claim 1, wherein the receiving portion includes a recessed structure having a regular polygonal shape.

6. The reinforced structural assembly of claim 1, wherein at least one of projecting structure and the recessed structure includes at least one recess disposed on a peripheral portion of the projecting structure and the recessed structure.

7. The reinforced structural assembly of claim 6, wherein the at least one recess comprises an elongated groove.

8. The reinforced structural assembly of claim 6, wherein the at least one recess comprises a substantially straight elongated groove.

9. The reinforced structural assembly of claim 1, wherein the projecting structure of the engaging portion has a rectangular planform having corners with a first radius, and wherein the recessed structure of the receiving portion has a corresponding rectangular planform having corners with a second radius, the first radius being greater that the second radius.

10. The reinforced structural assembly of claim 1, wherein the engagement portion and the receiving portion are comprised of at least one of a non-ferrous metal and a ferrous metal.

11. The reinforced structural assembly of claim 10, wherein the ferrous metal further includes a steel alloy.

12. The reinforced structural assembly of claim 1, wherein the engagement portion and the receiving portion are comprised of a polymeric material.

13. The reinforced structural assembly of claim 12, wherein the polymeric material includes a fiber-reinforced composite.

14. The reinforced structural assembly of claim 1, wherein the engagement portion includes a first substrate having a plurality of projecting structures extending outwardly therefrom, and wherein the receiving portion includes a second substrate having a corresponding plurality of recessed structures formed thereon, each of the recessed structures being adapted to slideably receive a respective one of the projecting structures to fixably secure the engagement portion to the receiving portion.

15. The reinforced structural assembly of claim 14, wherein at least some of the recessed structures include a wall portion projecting outwardly from the second substrate by a nominal wall height and at least one spacing member projecting outwardly from the second substrate by a spacing height, the spacing height being greater than the nominal wall height, the spacing members being adapted to maintain a distance between the first and second substrates when the plurality of projecting structures are engaged with the corresponding plurality of recessed structures that is greater than the nominal wall height.

16. A structural panel having enhanced flexural stiffness, comprising:
an engagement portion having at least one projecting structure extending outwardly from a first substrate; and
a receiving portion having at least one recessed structure coupled to a second substrate, the recessed structure having an interior region configured to slidably receive and fixably couple to the projecting structure, the engagement portion and the receiving portion being positioned between the first substrate and the second substrate.

17. The structural panel of claim 16, wherein the engagement portion includes a projecting structure having a regular polygonal shape.

18. The structural panel of claim 16, wherein the receiving portion includes a recessed structure having a regular polygonal shape.

19. The structural panel of claim 16, wherein at least one of projecting structure and the recessed structure includes at least one recess disposed on peripheral portion of the projecting structure and the recessed structure.

20. The structural panel of claim 16, wherein the projecting structure of the engaging portion has a rectangular planform having corners with a first radius, and wherein the recessed structure of the receiving portion has a corresponding rectangular planform having corners with a second radius, the first radius being greater that the second radius.

21. The structural panel of claim 16, wherein at least one of the engagement portion and the receiving portion are comprised of at least one of a non-ferrous metal, a ferrous metal, and a polymeric material.

22. The structural panel of claim 16, wherein the recessed structure of the receiving portion extends from the second substrate a first distance, the recessed structure further comprising corner regions that extend outwardly from the second substrate a second distance, the second distance being greater than the first distance.

23. The structural panel of claim 16, wherein the engagement portion includes a first substrate having a plurality of projecting structures extending outwardly therefrom, and wherein the receiving portion includes a second substrate having a corresponding plurality of recessed structures formed thereon, each of the recessed structures being adapted to slideably receive a respective one of the projecting structures to fixably secure the engagement portion to the receiving portion.

24. The structural panel of claim 23, wherein at least some of the recessed structures include a wall portion projecting outwardly from the second substrate by a nominal wall height and at least one spacing member projecting outwardly from the second substrate by a spacing height, the spacing height being greater than the nominal wall height, the spacing members being adapted to maintain a distance between the first and second substrates when the plurality of projecting structures are engaged with the corresponding plurality of recessed structures that is greater than the nominal wall height.

25. A method for constructing a reinforced structural assembly, comprising:
positioning at least one projecting structure on a first substrate;
positioning at least one recessed structure on a second substrate;
slidably coupling the at least one projecting structure and the at least one recessed structure; and
fixably securing the at least one projecting structure and the at least one recessed structure.

26. The method of claim 25, wherein positioning the at least one projecting structure on a first substrate further comprises adhesively bonding the at least one projecting structure to the first substrate.

27. The method of claim 25, wherein positioning the at least one recessed structure on a second substrate further comprises adhesively bonding the at least one recessed structure to the second substrate.

28. The method of claim 25, wherein positioning the at least one projecting structure on a first substrate further comprises fusing the at least one projecting structure to the first substrate.

29. The method of claim 25, wherein positioning the at least one recessed structure on a second substrate further comprises fusing the at least one recessed structure to the second substrate.

30. The method of claim 25, wherein positioning the at least one projecting structure comprises positioning a projecting structure having a regular polygonal shape onto the first substrate.

31. The method of claim 25, wherein positioning the at least one recessed structure comprises positioning a recessed structure having a regular polygonal shape onto the second substrate.

32. The method of claim 25, wherein the recessed structure of the receiving portion further comprises at least one recess circumferentially disposed within the interior region.

33. The method of claim 25, wherein positioning the at least one projecting structure comprises positioning a projecting structure having a rectangular planform and having corners with a first radius, and wherein positioning a recessed structure having a corresponding rectangular planform and having corners with a second radius, the first radius being greater that the second radius.

34. The method of claim 25, wherein positioning at least one recessed structure on a second substrate further comprises forming the recessed structure to extend from the second substrate a first distance, and forming the recessed structure to include corner regions that extend outwardly from the second substrate a second distance, the second distance being greater than the first distance.

35. The method of claim 34, wherein forming the recessed structure further comprises forming the recessed structure by machining the recessed structure to generate at least one of the first and the second distances.

36. An aerospace vehicle, comprising:
a fuselage;
wing assemblies and an empennage operatively coupled to the fuselage; and
a reinforced structural assembly comprising at least a portion of at least one of the fuselage, the wing assemblies and the empennage, the reinforced structural assembly further comprising:
an engagement portion having at least one projecting structure extending outwardly therefrom; and
a receiving portion having at least one recessed structure and having an interior region configured to slidably receive and fixably retain the projecting structure.

37. The aerospace vehicle of claim 36, wherein the engagement portion further includes a supporting substrate coupled to the projecting structure.

38. The aerospace vehicle of claim 36, wherein the receiving portion further includes a supporting substrate coupled to the recessed structure.

39. The aerospace vehicle of claim 36, wherein the engagement portion includes a projecting structure having a regular polygonal shape.

40. The aerospace vehicle of claim 36, wherein the receiving portion includes a circumferential recessed structure having a regular polygonal shape.

41. The aerospace vehicle of claim 36, wherein the recessed structure of the receiving portion further comprises at least one recess circumferentially disposed within the interior region.

42. The aerospace vehicle of claim 36, wherein the projecting structure of the engaging portion has a rectangular planform having corners with a first radius, and wherein the recessed structure of the receiving portion has a corresponding rectangular planform having corners with a second radius, the first radius being greater that the second radius.

43. The aerospace vehicle of claim 36, wherein at least one of the engagement portion and the receiving portion are comprised of at least one of a non-ferrous metal, a ferrous metal, and a polymeric material.

44. The aerospace vehicle of claim 36, wherein the engagement portion includes a first substrate having a plurality of projecting structures extending outwardly therefrom, and wherein the receiving portion includes a second substrate having a corresponding plurality of recessed structures formed thereon, each of the recessed structures being adapted to slideably receive a respective one of the projecting structures to fixably secure the engagement portion to the receiving portion.

45. The aerospace vehicle of claim 44, wherein at least some of the recessed structures include a wall portion projecting outwardly from the second substrate by a nominal wall height and at least one spacing member projecting outwardly from the second substrate by a spacing height, the spacing height being greater than the nominal wall height, the spacing members being adapted to maintain a distance between the first and second substrates when the plurality of projecting structures are engaged with the corresponding plurality of recessed structures that is greater than the nominal wall height.
